(19) United States
(12) Patent Application Publication
(10) Pub. No.: US 2008/0000039 A1
(43) Pub. Date: Jan. 3, 2008

(54) Heated Wiper Assembly

(76) Inventor: Eugene Higgs, Layton, UT (US)

Correspondence Address: Clark S. Cheney, Suite 300, 1177 Kane Concourse, Bay Harbor Islands, FL, 33154, US

(21) Appl. No.: 11/766,179

(22) Filed: Jun. 21, 2007

Related U.S. Application Data
(60) Provisional application No. 60/816,942, filed on Jun. 28, 2006.

(51) Int. Cl. B60S 1/38

(52) U.S. Cl. 15/250.07; 15/250.43; 219/202

(57) ABSTRACT

A heated wiper assembly assists in melting snow, sleet, slush, and ice on or around the windshield of a vehicle. The wiper assembly may comprise a housing, a wiper blade, and heating element. The heating element may comprise a self-regulating conductive core coupled between two bus wires. The heat output per unit of length of the heating element may be independent of the total length of the heating element.

This patent claims priority to provisional patent application No. 60/816,942, filed Jun. 28, 2006, and incorporated herein by reference.

### BACKGROUND

The present invention relates to a windshield wiper assembly that is heated. A heated windshield wiper assembly may assist in melting snow, sleet, slush, and ice on or around the windshield of a vehicle.

Vehicle operators desire clear visibility through a windshield to safely operate a vehicle. During inclement weather, snow, sleet, slush, or ice may accumulate on or around a windshield, making it difficult for the vehicle operator to see out the windshield or to safely operate the vehicle.

Traditional windshield wipers may assist in clearing precipitation from the windshield to allow the vehicle operator to see. Traditional windshield wipers work by constantly or intermittently moving one or more blades composed of rubber, plastic, polymer, or other flexible materials over the surface of the windshield. The blade pushes precipitation away from a central area of the windshield to a more remote area to create a field of visibility for the vehicle operator. Because many windshields have a curved or convex surface, some windshield wiper blades are flexible along their length to allow continuous contact with the curved surface of the windshield.

However, severe weather conditions, such as cold, stormy weather with precipitation, may cause ice or slush to accumulate on or around the windshield and on or around a windshield wiper assembly. In such conditions, a traditional windshield wiper may not be able to adequately clear accumulating precipitation. In addition, if a vehicle is traveling at a high speed, the additional wind chill caused by the vehicle's movement may also contribute to the freezing or accumulation of precipitation on or around the windshield and the windshield wiper assembly. When snow, sleet, slush, ice, or other precipitation collect on or around the windshield wiper assembly, the windshield wiper may not operate correctly. For example, the weight of the collecting precipitation may become greater than the windshield wiper's ability to push the precipitation away. Collecting precipitation may also cause the windshield wiper blade to be raised up off of the surface of the windshield, thereby decreasing the wiper's effectiveness in clearing the surface of the windshield.

In such severe weather conditions, a vehicle operator must often stop the vehicle and clear the windshield manually. The vehicle operator may also be required to manually free the windshield wiper assembly from accumulated snow, ice, or precipitation. It may be dangerous to stop a vehicle on the side of the road in severe weather conditions where the visibility of other drivers has been impaired.

Commercial vehicle operators may be especially affected by severe weather conditions. Unlike leisure travelers, commercial vehicle operators often must drive in adverse weather conditions. Because commercial vehicle operators like truck drivers are often paid by the mile, time spent clearing a windshield can mean decreased productivity and decreased pay.

Accordingly, it would be desirable to have a windshield wiper that performs better than a traditional windshield wiper in cold, stormy weather.

### SUMMARY

The present invention relates to a windshield wiper assembly that is heated. A heated windshield wiper assembly may assist in melting snow, sleet, slush, and ice on or around the windshield of a vehicle.

According to one embodiment, the invention may comprise a housing, a wiper blade, and a heating element. In another embodiment of the invention, the heating element comprises a self-regulating conductive core coupled between two bus wires. In still another embodiment of the invention, the heat output per unit of length of the heating element is independent of the total length of the heating element. Other embodiments and other applications of the invention are discussed in more detail herein.

### BRIEF DESCRIPTION OF THE DRAWINGS

The accompanying drawings illustrate a number of exemplary embodiments and are a part of the specification. Together with the following description, these drawings demonstrate and explain various principles of the instant disclosure.

FIG. 1 is a wiper assembly according to one embodiment of the present invention;

FIG. 2 is one embodiment of a housing of the invention before assembly;

FIG. 3 is a view of a housing and a heating element according to one embodiment of the invention;

FIG. 4 is one embodiment of a heating element of the invention; and

FIG. 5 is a cut-away view of one embodiment of a heating cable useful within the invention.

### DETAILED DESCRIPTION

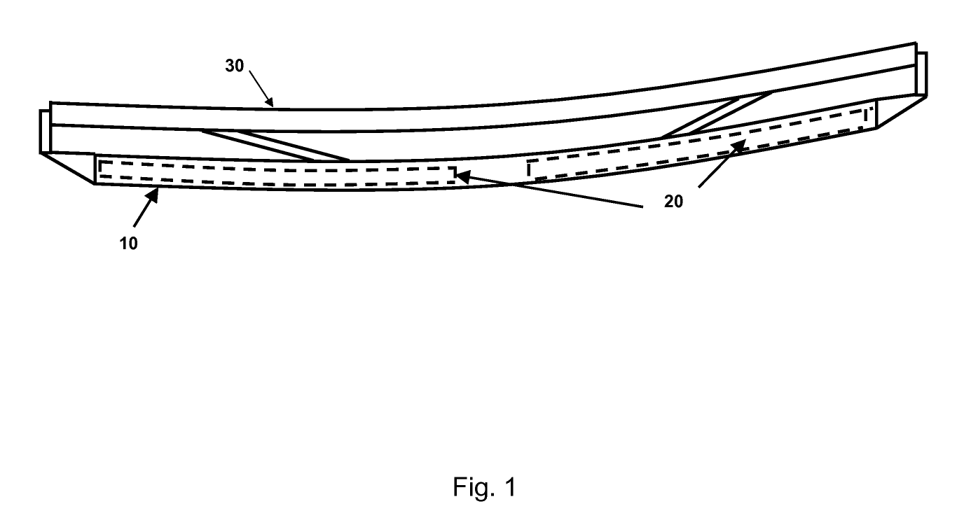

As shown in FIG. 1, the invention may comprise a housing 10, a heating element 20, and a wiper blade 30. The housing may be connected to a windshield wiper arm (not shown) such as is known in the art. The housing may be connected to a windshield wiper arm such as is known in the art. The wiper assembly of the present invention is suitable for use with constant or intermittent wiper actuators such as are known in the art.

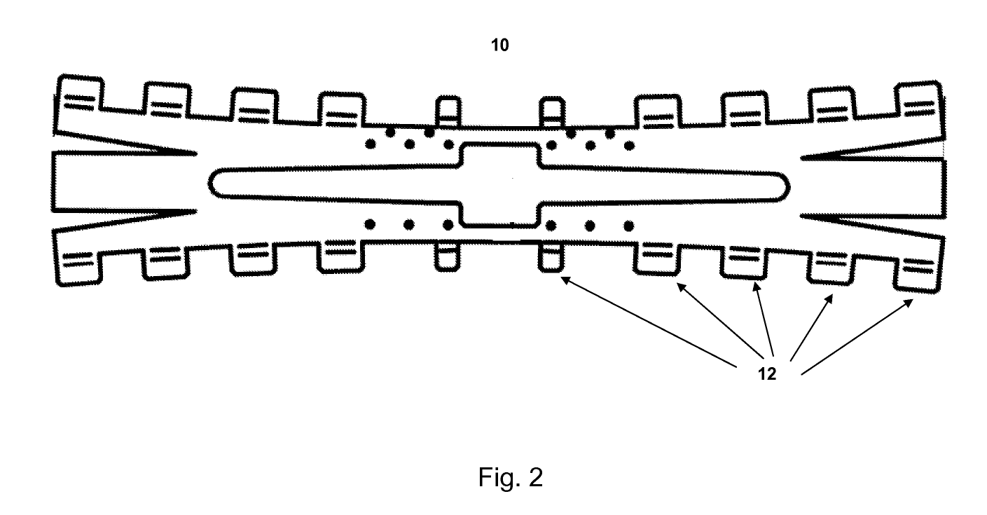

One embodiment of housing 10 is shown in more detail in FIG. 2. Housing 10 may be made from any suitable material and may conform to any suitable shape or configuration. In particular, the shape of housing 10 may be adapted to conform with the type of wiper arm to which it will be attached and the type or shape of windshield or other surface it will be used to clear. In some embodiments, the length of housing 10 is chosen from a range of about 10 inches to about 30 inches. Other lengths may be appropriate, depending on the desired application. When multiple wiper arms are used in the same application, differing housing lengths may be used on each arm, as will occur to those skilled in the art.

The embodiment shown in FIG. 2 is by way of example only. In the embodiment of FIG. 2, housing 10 may be die cut from stainless steel in one piece and folded to form the housing. Of course, materials other than stainless steel (e.g., aluminum, other alloys, plastics) and methods of manufacture other than die cutting (e.g., molding) may also be used to construct housing 10. Such materials and methods are known to those skilled in the art. In the embodiment shown in FIG. 2, stainless steel is selected because of its durable and heat conductive properties.

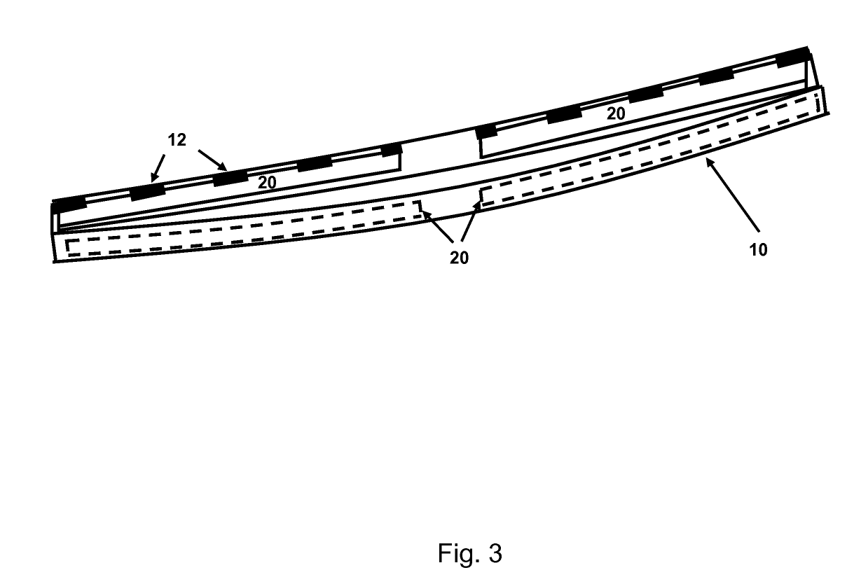

Heating element 20 may be any heating element known to those skilled in the art. One embodiment of heating element 20 is shown in FIG. 3. As shown in FIG. 3, heating element 20 is arranged along the length of housing 20 and is held in place by folded tabs 12 on housing 10. Any suitable method of attaching heating element 20 to housing 10 may be used.

In the embodiment shown in FIG. 3, heating element 20 is a resistance heater powered by electricity. However, in other embodiments of the invention, heating element 20 may be powered by other sources of energy. Other embodiments of the invention may use heating elements other than resistance heating elements.

In the embodiment of the invention shown in FIG. 3, heating element 20 may heat housing 10 by conduction at points where heating element 20 is in contact with housing 10. Heating element 20 may also heat housing 10 by convection or radiation. Heating element 20 may heat wiper blade 30 (FIG. 1) and a vehicle windshield (not shown) by conduction, convection, or radiation. Heat from heating element 20 may assist in keeping snow, sleet, slush, ice, or other precipitation from accumulating on or around the wiper assembly and the windshield.

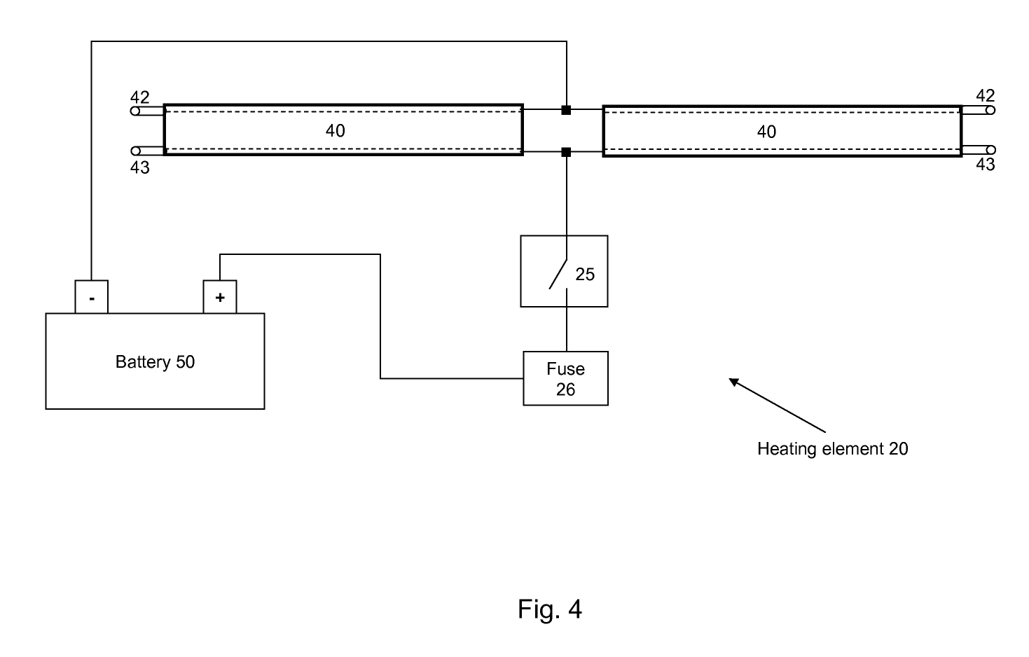

One embodiment of heating element 20 is shown in more detail in FIG. 4. In FIG. 4, heating element 20 may comprise a heating cable 40 having a self-regulated conductive core 41 extended between bus wires 42 and 43. As shown in FIG. 4, conductive core 41 may be in contact with more than 50% of the length of wires 42, 43.

As shown in FIG. 4, one end of bus wire 42 may be coupled to an electrical ground; the other end of bus wire 42 may remain unconnected. One end of bus wire 43 may be coupled to the positive source of an electrical supply 50; the other end of bus wire 43 may remain unconnected. In one embodiment of the invention, the electrical supply for heating element 20 is a 12 volt battery 50. Heating element 20 may be supplied by the same power source as the wiper arm actuator or from a different power source.

Those skilled in the art will appreciate that switch 24 and fuse 25 shown in FIG. 4 are optional or may be configured in other combinations or arrangements according to the application in which the wiper assembly will be used. For example, switch 24 may be connected to the same switch as the wiper arm actuator so that heating element 20 operates in consort with such an actuator. In another embodiment of the invention, heating element 20 may be switched independently of the movement of the wiper assembly. Further, the voltage supply and/or current supply for heating element 20 may vary according to design requirements for the heating element and vehicle selected for use with the invention.

Several sections heating cable 40 may be used with a single housing 10. In one embodiment of the invention, four sections of heating cable are used, with two sections arranged along each side of housing 10. Such an embodiment may facilitate an electrical connection at the center of the length of housing 10 (e.g., where housing 10 may be connected to a wiper arm). The embodiment may also facilitate wiring connections between the cable sections at the ends of housing 10. Other embodiments may use a single piece of heating cable 40. For example, a single piece of heating cable 40 may be disposed along only one side of housing 10. Alternatively, a single heating cable 40 may encircle both sides of housing 10.

In still other embodiments of the invention, other numbers of heating cable pieces and other wiring configurations may be used. For example, two or more pieces of heating cable may be connected in series. Alternatively, two or more pieces of heating cable 40 may be connected in parallel. The ends of heating cable sections that are not connected to a power supply and ground may or may not be connected to one or more additional heating cable sections and may or may not be connected to other wires. Heating cable 40 may be disposed inside or outside of housing 10.

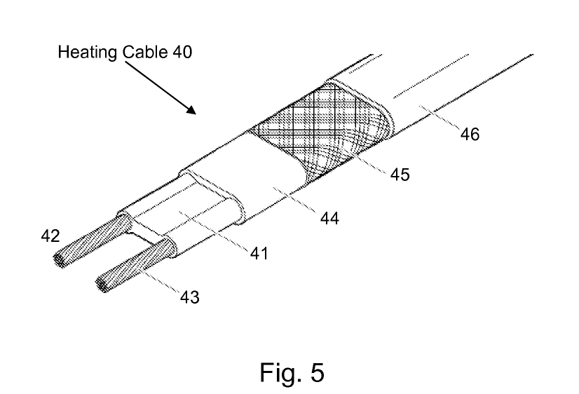

One embodiment of heating cable 40 is shown in more detail in FIG. 5. As shown in FIG. 5, heating cable 40 may comprise bus nickel-plated copper bus wires 42 and 43 embedded in a self-regulating conductive core 41. Conductive core 41 may be covered successively with a modified polyolefin inner jacket 44, a metal braid 45, and a fluoropolymer outer jacket 46. Braid 45 may be a tinned copper braid with a resistance less than the heating cable bus wire resistance.

The operation of the embodiment of heating cable 20 shown in FIG. 5 will now be described in greater detail. In one embodiment of the invention, heating cable 40 may maintain process temperatures during exposure to environmental temperatures as low as −40° F. (−40° C.). In another embodiment of the invention, heating cable 40 may maintain process temperatures during exposure to environmental temperatures of up to 420° F. (215° C.).

Self-regulating polymeric core 41 within heating cable 40 may control power output without the use of a separate thermostat. In one embodiment of the invention, heating cable 40 maintains a nearly constant temperature of about 150° F. (65° C). In other embodiments of the invention, heating cable may maintain a temperature within the range of about 105-150° F. (about 40-65° C.). In still other embodiments of the invention, the heating cable may maintain a nearly constant temperature selected from a range of about 32° F. (0° C.) to 482° F. (about 250° C.).

Heating cable 40 may be used directly on housings made of metal, plastic, or other materials. Heating cable 40 may have a minimum self-regulating index appropriate for the type of housing 10 with which it is used such that the heating of the cable may not damage housing 10 or the windshield. The self-regulating index is the rate of change of power output in watts per degree Fahrenheit or watts per degree Celsius, as measured between the temperatures of 50° F. (10° C.) and 100° F. (38° C.). In one embodiment, heating cable 40 has a self-regulating index selected from the range of 0.028 W/ft·° F. (0.16 W/m·° C.) to 0.100 W/ft·° F. (0.18 W/m·° C.). Conductive core 41 may continually adjust its heat output in relation to changing temperature conditions at various points along wiper housing 10. As ambient or housing temperatures change, conductive core 41 may expand or contract, altering the resistance of the core and in turn the amount of heat produced.

Heating cable 40 may be selected from cables that can provide temperature maintenance and freeze protection for continuous circuit lengths up to 2000 feet (610 m) respectively powered from a single source. Heating cable 40 may be selected such that within the circuit length limitations, the heat output per unit of length is independent of the heating cable's total length. In one embodiment, the heat output per foot may be selected from the range of about 3 watts per foot to about 10 watts per foot. In one embodiment of the invention, heating cable 40 is LBTV-type heating cable such as that commercially available from RayChem. One embodiment may use heating cable adapted for operation at 12 V; other heating cable embodiments may operate at 40 V, 120 V, 205 V, 220 V, or any other suitable voltage.

As will be appreciated, other circuits appropriate for LBTV-type heating cable are known in the art and are contemplated for use within the invention. Various other resistance heaters and corresponding circuits known in the art may also be used in heating element 20.

In one embodiment of the invention, the wiper assembly may be used on a vehicle window other than the windshield, for example, the rear view window. The invention contemplates usage on windows other than automobile windows, including windows on trucks, vans, minivans, motorcycles, scooters, mopeds, golf carts, etc. The wiper assembly of the present invention may be used on flat, convex, or concave surfaces. The invention may also be used to clear surfaces other than glass surfaces, including without limitation plexiglass, plastic, thermoplastic, synthetic, and metal surfaces. The wiper assembly of the present invention may be used alone or in combination with one or more other wiper assemblies.

It is to be understood that the above-described arrangements are only illustrative of the application of the principles of the present invention. Numerous modifications and alternative arrangements may be devised by those skilled in the art without departing from the spirit and scope of the present invention and the appended claims are intended to cover such modifications and arrangements. Thus, while the present invention has been shown in the drawings and fully described above with particularity and detail in connection with what is presently deemed to be the most practical and preferred embodiment(s) of the invention, it will be apparent to those of ordinary skill in the art that numerous modifications, including, but not limited to, variations in size, materials, shape, form, function and manner of operation, assembly and use may be made, without departing from the principles and concepts of the invention.

I claim:

1. A heated wiper assembly comprising:
a housing,
a wiper blade attached to said housing,
a heating element attached to said housing, wherein said heating element comprises a self-regulating conductive core.

2. The heated wiper assembly of claim 1, wherein the heat output per unit of length of said heating element is independent of the total length of said heating element.

3. The heated wiper assembly of claim 1, wherein the self-regulating conductive core has a self-regulating index selected from the range of about 0.028 W/ft·° F. (0.16 W/m·° C.) to 0.100 W/ft·° F. (0.18 W/m·° C.).

4. The heated wiper assembly of claim 1, wherein the self-regulating conductive core operates at about 12 V.

5. The heated wiper assembly of claim 1, wherein the self-regulating conductive core operates at about 40 V.

6. The heated wiper assembly of claim 1, wherein the self-regulating conductive core alters its resistance by expanding or contracting.

7. A heated wiper assembly comprising:
a housing,
a wiper blade attached to said housing,
a heating element attached to said housing, wherein the heat output per unit of length of said heating element is independent of the total length of said heating element.

8. The heated wiper assembly of claim 7, wherein the heating element comprises a self-regulating conductive core.

9. The heated wiper assembly of claim 8, wherein the self-regulating conductive core alters its resistance by expanding or contracting.

10. The heated wiper assembly of claim 8, wherein the self-regulating conductive core is polymeric.

11. The heated wiper assembly of claim 8, wherein the self-regulating conductive core has a self-regulating index selected from the range of about 0.028 W/ft·° F. (0.16 W/m·° C.) to 0.100 W/ft·° F. (0.18 W/m·°C.).

12. The heated wiper assembly of claim 7, wherein the heating element operates at 12 V.

13. The heated wiper assembly of claim 7, wherein the heating element operates at 40 V.

14. An apparatus comprising:
a housing,
a wiper blade attached to said housing, and
a heating cable attached to said housing, said heating cable comprising:
a first wire coupled to an electrical ground,
a second wire coupled to a positive electrical source, and
a conductive element disposed between said first and said second wires.

15. The apparatus of claim 14, wherein the conductive element contacts greater than 50% of length of first wire and second wire.

16. The apparatus of claim 14, wherein said conductive element comprises a self-regulating conductive core.

17. The apparatus of claim 14, wherein the heat output per foot of said heating element is independent of the length of said heating element.

18. The apparatus of claim 14, wherein the conductive element has a self-regulating index selected from the range of about 0.028 W/ft·° F. (0.16 W/m·° C.) to 0.100 W/ft·° F. (0.18 W/m·° C.).

19. The apparatus of claim 14, wherein the heating cable operates at 12 V.

20. The apparatus of claim 14, wherein the heating cable operates at 40 V.
